(19) United States
(12) Patent Application Publication
(10) Pub. No.: US 2007/0103131 A1
(43) Pub. Date: May 10, 2007

(54) DC-DC converter and organic light emitting display using the same

(76) Inventor: Dong Yong Shin, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/591,942

(22) Filed: Nov. 2, 2006

(30) Foreign Application Priority Data
Nov. 7, 2005 (KR) 10-2005-106169

(51) Int. Cl. G05F 1/00

(52) U.S. Cl. 323/280

(57) ABSTRACT

A DC-DC converter capable of improving a response characteristic of the signal and reducing power consumption; and an organic light-emitting display using the same are disclosed. The converter has a comparator for receiving an input voltage and a reference voltage and determining an output to correspond to a difference between the input voltage and the reference voltage. The comparator has a feedback path which improves the response time and power consumption characteristics of the converter.

### CROSS-REFERENCE TO RELATED APPLICATIONS

This application claims the benefit of Korean Patent Application No. 2005-0106169, filed on Nov. 7, 2005, in the Korean Intellectual Property Office, the disclosure of which is incorporated herein by reference in its entirety.

### BACKGROUND OF THE INVENTION

1. Field of the Invention

The present invention relates to a DC-DC converter and an organic light-emitting display using the same, and more specifically to a DC-DC converter configured to output a voltage according to a comparison result obtained by comparing an input voltage with a reference voltage; and an organic light-emitting display using the same.

2. Description of the Related Technology

FIG. 1 is a circuit diagram showing a previous comparator. Referring to FIG. 1, the comparator includes an input unit and first, second and third inverters.

The input unit has a first switch SW1 for switching transmission of the input voltage Vin; and a second switch SW2 for switching transmission of a reference voltage Vref.

The first inverter has a first transistor M1 as the P MOS transistor and a second transistor M2 as the N MOS transistor. And the first power supply Vdd is connected to a source of the first transistor M1 to supply a high level of voltage, and the second transistor M2 has a source connected to a ground GND to supply a low level of voltage. And, the first capacitor C1 and the third switch SW3 are connected to the first node N1.

The second inverter has a third transistor M3 as the P MOS transistor and a fourth transistor M4 as the N MOS transistor. And the first power supply Vdd is connected to a source of the third transistor M1 to supply a high level of voltage, and a ground is connected to a source of the fourth transistor M4 to supply a low level of voltage. And, the second inverter is connected with the first inverter through the second capacitor C2, and terminals of the second capacitor C2, the fourth switch M4, and the third and fourth transistors M3,M4 are connected to the second node N2.

The third inverter has a fifth transistor M5 as the P MOS transistor and a sixth transistor M6 as the N MOS transistor. And the first power supply Vdd is connected to a source of the fifth transistor M5 to supply a high level of voltage, and a ground is connected to a source of the sixth transistor M6 to supply a low level of voltage.

FIG. 2 is a timing diagram showing input/output waveforms of the circuit shown in FIG. 1. Referring to FIG. 2, an input voltage Vin input at an input terminal of a comparator unit changes in a voltage level and is compared with the reference voltage Vref. The first to fifth switches SW1 to SW5 conduct a switching operation according to the first control signal P1 and the second control signal P2, where the first, third and fourth switches SW1, SW3, SW4 are operated according to the first control signal P1 and the second and fifth switches SW2, SW5 are operated by the second control signal P2.

Firstly, if the first, third and fourth switches SW1, SW3, SW4 are turned on by the first control signal P1 and the second and fifth switches SW2, SW5 are turned off by the second control signal P2, then the input voltage Vin is transmitted to the first capacitor C1, and the voltage corresponding to a threshold voltage difference between the first inverter and the second inverter is stored in the second capacitor C2.

And, if the first, third and fourth switches SW1, SW3, SW4 are subsequently turned off by the first control signal P1 and the second and fifth switches SW2, SW5 are turned on by the second control signal P2, then the reference voltage Vref is transmitted to the first capacitor C1 to compare the input voltage Vin with the reference voltage Vref.

At this time, if the input voltage Vin is higher than the reference voltage Vref, then an output port of the third inverter outputs a low level of voltage, and if the input voltage Vin is lower than the reference voltage Vref, then an output port of the third inverter outputs a high level of voltage.

In the comparator described above, the output voltage is determined according to a difference between the reference voltage Vref and the input voltage Vin in the first capacitor C1, and therefore the comparator has a problem in that it takes more time to change the output voltage into the high level or the low level if there is not a high difference between the reference voltage Vref and the input voltage Vin than if there is a high difference between the reference voltage Vref and the input voltage Vin.

In order to address the problem, the comparator as described above can have a large capacitance, and therefore it has a problem because its power consumption is increased due to a large consumption of the current.

### SUMMARY OF CERTAIN INVENTIVE ASPECTS

Accordingly, certain instant embodiments solve such drawbacks of the device discussed above, and therefore can provide a DC-DC converter capable of improving a response time characteristic of the signal and also reducing power consumption.

One embodiment is a comparator configured to receive an input voltage and a reference voltage and to determine an output corresponding to a difference between the input voltage and the reference voltage. The comparator includes an input unit configured to transmit the input voltage to a first stage and to transmit the reference voltage to a second stage, and an amplification unit including a first capacitor configured to store the input voltage and the reference voltage, a second capacitor configured to receive a feedback voltage and to transmit the feedback voltage to the first capacitor, and at least one inverter configured to output signals corresponding to the voltage stored in the first capacitor and the second capacitor. The comparator also includes a feedback unit configured to receive a voltage output in the amplification unit when the input voltage is transmitted, a voltage output unit in the amplification unit, the voltage output unit configured to generate the feedback voltage when the reference voltage is transmitted, where the feedback unit is configured to modify a difference voltage corresponding to the difference between the input voltage and the reference voltage according to the feedback voltage, and an output unit configured to receive the output voltage of the amplification unit and to output a voltage based on the output voltage of the amplification unit.

Another embodiment is a DC-DC converter including a charge pump with a voltage output terminal configured to vary and output a voltage according to a voltage at a voltage input terminal, and a signal input terminal. The DC-DC converter also includes a comparator configured to receive a comparator input voltage and a reference voltage and to determine an output voltage corresponding to a difference between the comparator input voltage and the reference voltage. The comparator includes an input unit configured to transmit the input voltage to a first stage and to transmit the reference voltage to a second stage, and an amplification unit. The amplification unit includes a first capacitor configured to store the input voltage and the reference voltage, a second capacitor configured to receive a feedback voltage and to transmit the feedback voltage to the first capacitor, and at least one inverter configured to output signals corresponding to the voltage stored in the first capacitor and the second capacitor. The comparator also has a feedback unit configured to receive a voltage output in the amplification unit when the input voltage is transmitted, a voltage output unit in the amplification unit, the voltage output unit configured to generate the feedback voltage when the reference voltage is transmitted, where the feedback unit is configured to modify a difference voltage corresponding to the difference between the input voltage and the reference voltage according to the feedback voltage, and an output unit configured to receive the output voltage of the amplification unit and to output a voltage based on the output voltage of the amplification unit.

Another embodiment is a organic light-emitting display including a pixel unit configured to display an image corresponding to data signals and scan signals, a data driver configured to transmit the data signals to the pixel unit, a scan driver configured to transmit the scan signals to the pixel unit, and a DC-DC converter to transmit a power supply to the pixel unit, the data driver and the scan driver. The DC-DC converter includes a comparator including an input unit configured to transmit the input voltage to a first stage and to transmit the reference voltage to a second stage, an amplification unit including a first capacitor configured to store the input voltage and the reference voltage, a second capacitor configured to receive a feedback voltage and to transmit the feedback voltage to the first capacitor, and at least one inverter configured to output signals corresponding to the voltage stored in the first capacitor and the second capacitor. The comparator also includes a feedback unit configured to receive a voltage output in the amplification unit when the input voltage is transmitted, a voltage output unit in the amplification unit, the voltage output unit configured to generate the feedback voltage when the reference voltage is transmitted, where the feedback unit is configured to modify a difference voltage corresponding to the difference between the input voltage and the reference voltage according to the feedback voltage, and an output unit configured to receive the output voltage of the amplification unit and to output a voltage based on the output voltage of the amplification unit.

### BRIEF DESCRIPTION OF THE DRAWINGS

These and/or other aspects and advantages will become apparent and more readily appreciated from the following description of certain embodiments, taken in conjunction with the accompanying drawings of which:

FIG. 1 is a circuit diagram showing a previous comparator;

FIG. 2 is a timing diagram showing input/output waveforms of the circuit shown in FIG. 1;

FIG. 3 is a schematic view showing a configuration of an organic light-emitting display;

FIG. 4 is a schematic view showing a DC-DC converter used in the organic light-emitting display shown in FIG. 3;

FIG. 5 is a circuit diagram showing an embodiment of the comparator used in the DC-DC converter shown in FIG. 4;

FIG. 6 is a characteristic curve showing an output property of the comparator shown in FIG. 5;

FIG. 7 is a circuit diagram showing another embodiment of the comparator used in the DC-DC converter shown in FIG. 4;

FIG. 8 is a circuit diagram showing yet another embodiment of the comparator used in the DC-DC converter shown in FIG. 4;

FIG. 9 is a circuit diagram showing still another embodiment of the comparator used in the DC-DC converter shown in FIG. 4;

FIG. 10 is a circuit diagram showing another embodiment of the comparator used in the DC-DC converter shown in FIG. 4;

FIG. 11 is a circuit diagram showing still another embodiment of the comparator used in the DC-DC converter shown in FIG. 4; and

FIG. 12 is a circuit diagram showing yet another embodiment of the comparator used in the DC-DC converter shown in FIG. 4.

### DETAILED DESCRIPTION OF CERTAIN INVENTIVE EMBODIMENTS

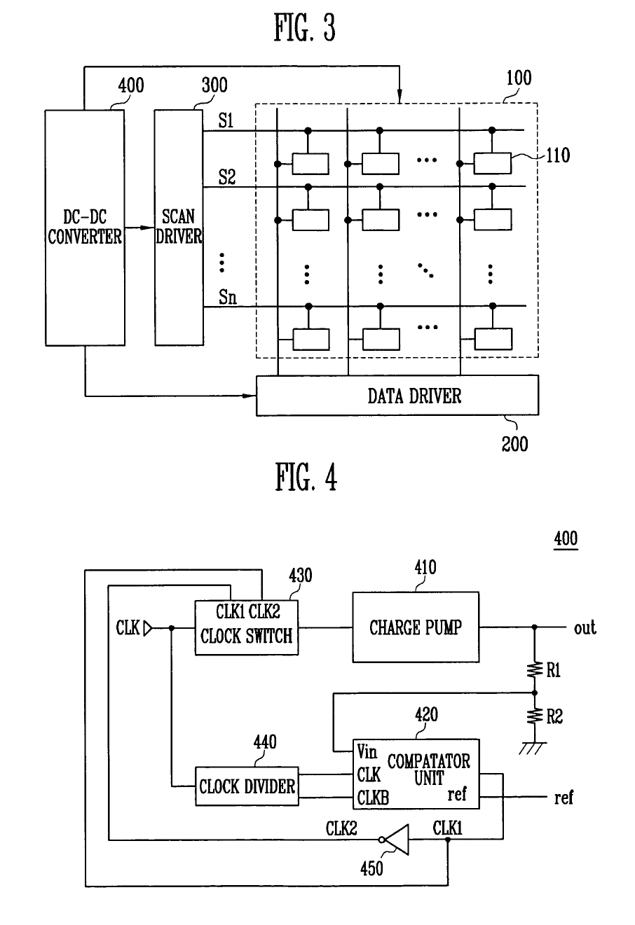

FIG. 3 is a schematic view showing a configuration of an organic light-emitting display according to some embodiments. Referring to FIG. 3, the organic light-emitting display has a pixel unit 100, a data driver 200, a scan driver 300 and a DC-DC converter 400.

In the pixel unit 100, a plurality of data lines D1 to Dm and a plurality of scan lines S1 to Sn cross each other, and pixels 110 are formed in regions in which the data lines D1 to Dm and the scan lines S1 to Sn cross. The pixels 110 present an image by displaying a gray level corresponding to data signals transmitted through the data lines D1 to Dm and scan signals transmitted through the scan lines S1 to Sn.

The data driver 200 is connected with a plurality of the data lines D1 to Dm to transmit data signals to a plurality of the data lines in parallel, and to simultaneously transmit data signals to a pixel row arranged in a latitudinal direction of the pixel unit 100.

The scan driver 300 is connected with a plurality of the scan lines S1 to Sn to transmit scan signals to a specific pixel 110 by transmitting the scan signals to the pixel 110 to which the scan signals are to be transmitted.

The DC-DC converter 400 converts a D.C. power supply level, transmitted from the outside, to a suitable D.C. power supply level for each electrical load and transmits the D.C. power supply level to each of the electrical loads, and the D.C. power supply level generated in the DC-DC converter 400 is transmitted to the pixel unit 100, the data driver 200 and the scan driver 300, etc.

FIG. 4 is a schematic view showing an embodiment of a DC-DC converter used in the organic light-emitting display shown in FIG. 3. Referring to FIG. 4, the DC-DC converter includes a clock switch 430, a charge pump 410, a clock divider 440 and a comparator 420.

The clock switch 430 receives clocks from a clock generation unit CLK, and adjusts the clocks generated in the clock generation unit CLK using the first clock CLK1 and the second clock CLK2 transmitted through the inverter 450.

The charge pump 410 synchronizes with the first clock CLK1 and the second clock CLK2, and charges a capacitor to generate a higher voltage or lower voltage than the input voltage, and output the generated voltage to each of the driving units.

The clock divider 440 transmits the clocks CLK, CLKB from the clock generation unit CLK to the comparator unit 420 to operate the comparator unit 420.

The comparator 420 is synchronized by the clocks CLK, CLKB, and compares a reference voltage ref with an input voltage Vin by receiving the input voltage Vin from an output port of the charge pump 410 and receiving the reference voltage ref through the reference voltage source, and allows the clock switch 430 to be operated by the first clock CLK1 and the second clock CLK2 by transmitting the compared signals to the clock switch 430 through the inverter 450. This allows a charge pump to control an output voltage corresponding to the first clock (CLK1) and the second clock CLK2.

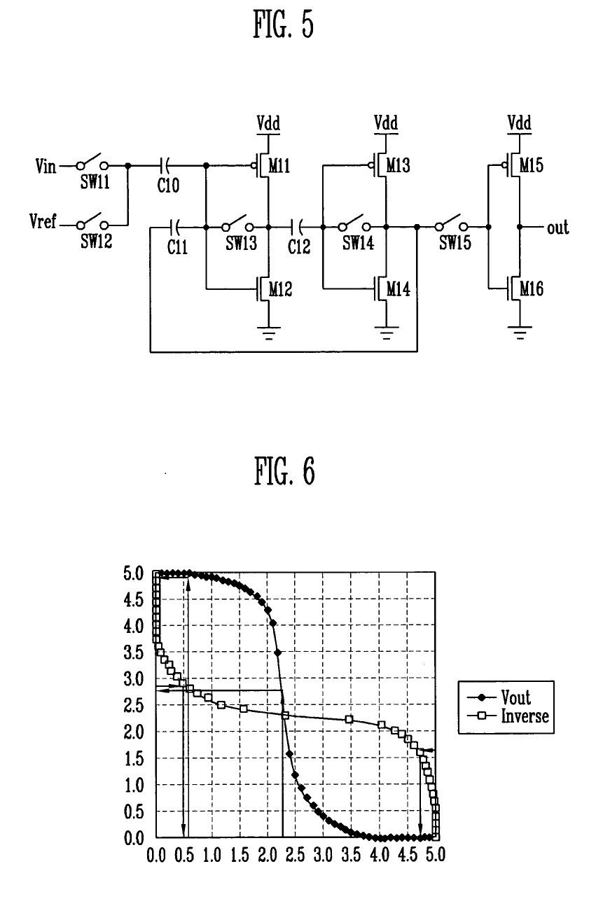

FIG. 5 is a circuit diagram showing an embodiment of the comparator used in the DC-DC converter shown in FIG. 4. Referring to FIG. 5, the comparator 420 has an input unit and first, second, and third inverters.

Referring to FIG. 5, the input unit has an input voltage connected with the capacitor C10 through the first switch SW11, and a reference voltage Vref connected with the capacitor C10 through the second switch SW12. The capacitor C10 is connected with the gates of the first and second transistors of the first inverter.

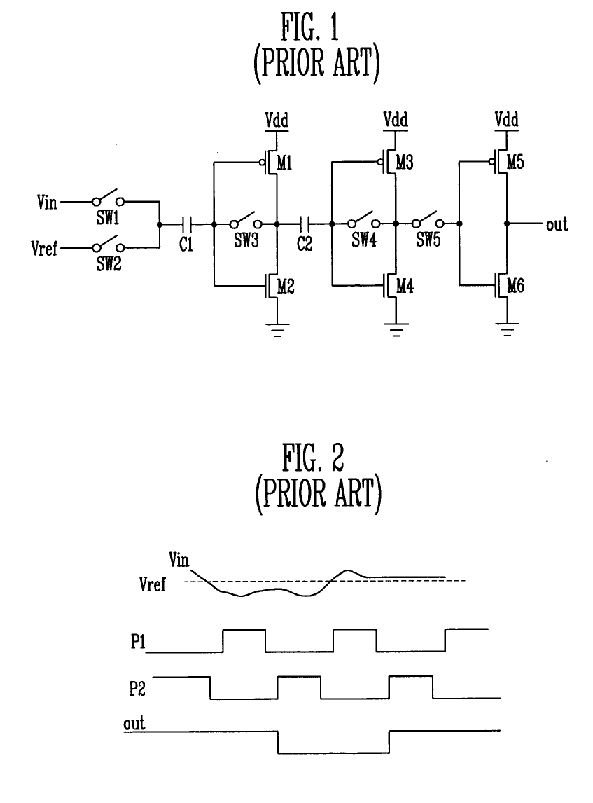

The capacitor C11 has a first electrode connected with the gates of the first and second transistors M11 and M12 of the first inverter, and a second electrode connected between a fourth switch SW14 and a fifth switch SW15. Also, the first, second, and third inverters are connected in the same manner as in FIG. 1. and therefore signals output through the output port of the second inverter are transmitted by means of switching operations of the fourth switch SW14 and the fifth switch SW15.

The comparator can be operated according the signals shown in FIG. 2, where the first switch SW11, the third switch SW13, the fourth switch SW14 conduct the switching operation according to the first control signal P1, the second switch SW12 and the fifth switch SW15 conduct the switching operation according to the second control signal P2 in the comparator.

Operation of the comparator will be described with reference to FIGS. 2 and 5. Firstly, the first switch SW11, the third switch SW13 and the fourth switch SW14 are turned on by the first control signal P1, and the second switch SW12 and the fifth switch SW15 are turned off by the second control signal P2. Accordingly, an input voltage Vin is transmitted to a capacitor C10, and the voltage corresponding to a threshold voltage difference between the first inverter and the second inverter is stored in the second capacitor C12. The third inverter is at a floating state since the fifth switch SW15 remains turned off. At this time, the output voltage of the second inverter is stored in the first capacitor C11 by the output port of the second inverter, and the voltage stored in the first capacitor C11 is transmitted to the gates of the first and second transistors M11 and M12 of the first inverter, and therefore, the output voltage of the first inverter is controlled by the voltage stored in the first capacitor C11.

If the second switch SW12 and the fifth switch SW15 are turned on by the second control signal P2, then the voltage transmitted to the capacitor C10 is changed from the input voltage Vin to the reference voltage Vref, and the third switch SW13 is open, and therefore the voltages transmitted to the first inverter is changed. Accordingly, the voltage transmitted to the second inverter is changed.

Furthermore, if the output signals of the second inverter are transmitted to the first capacitor C11 by the second control signal P2, then the fifth switch SW15 is turned on during a period in which the second switch SW12 is turned on, and therefore a feedback operation is conducted during the time when the reference signal Vref is transmitted. The fluctuation range of the output voltage of the third inverter is further increased by such a feedback operation, resulting in improvement of the response characteristics of the signal.

FIG. 6 is a characteristic curve showing an output property of the comparator shown in FIG. 5. Referring to FIG. 6, Vout represents a characteristic curve of the inverter, and Inverse represents a curve in which the characteristic curve of the inverter is at a reversed state.

The characteristic curve shows that the output changes significantly around an input of 2.5V, and is substantially stable in two points having a large difference between the input voltage and the reference voltage, allowing the output of the comparator to output high or low signals. Because of the feedback procedure discussed above, the response characteristics of the signal are improved.

FIG. 7 is a circuit diagram showing another embodiment of the comparator used in the DC-DC converter shown in FIG. 4. Unlike the comparator shown in FIG. 5, since the capacitor C20 and the first capacitor C21 are connected in series, the capacitor C20 and the first capacitor C21 transmit the voltage to the first inverter, and the feedback voltage is also distributed onto the capacitor C20 and the first capacitor C21, before being transmitted to the first inverter.

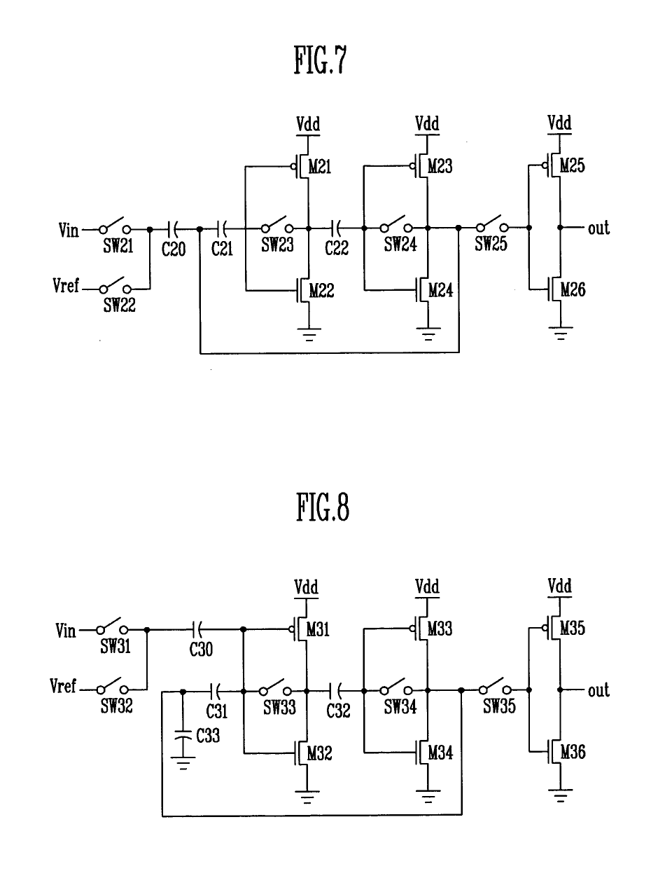

FIG. 8 is a circuit diagram showing another embodiment of the comparator used in the DC-DC converter shown in FIG. 4. Capacitor C30 is further included so as to stabilize an operation of the comparator. Capacitor C31 is connected to the input of the first inverter and a third capacitor C33 connected to capacitor C31 and to ground. The third capacitor C33 stores and holds the voltage output of the second inverter when the comparator is operated by the first control signal P1. Accordingly, the output of the comparator is substantially prevented from moving between the stable points when the comparator is operated by the second control signal P2, and therefore waveforms of the signals output in the comparator are improved.

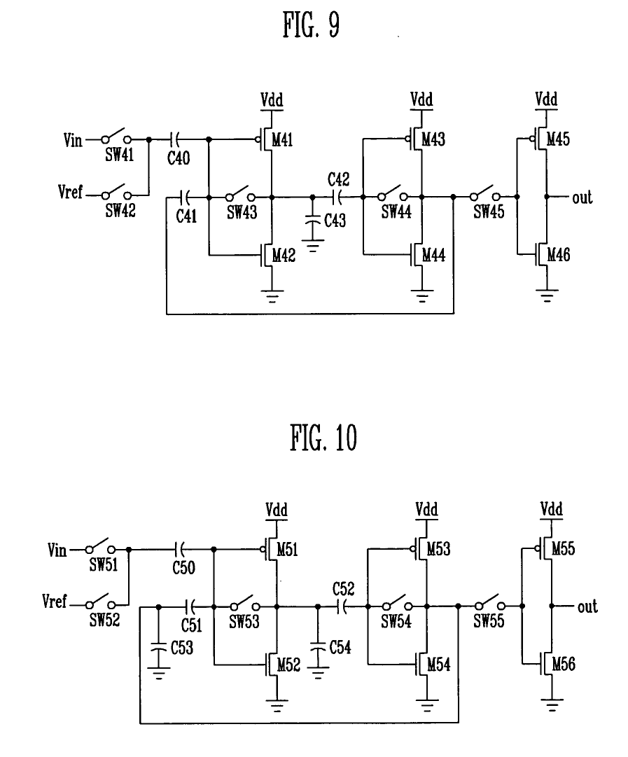

FIG. 9 is a circuit diagram showing yet another embodiment of the comparator used in the DC-DC converter shown in FIG. 4. A capacitor C43 is included to stabilize the time point when the signals output from the comparator. A second capacitor C42 is connected between the first inverter and the second inverter and a third capacitor C43 is connected between the first inverter and ground, and therefore waveforms of the output signals of the comparator are stabilized.

FIG. 10 is a circuit diagram showing still another embodiment of the comparator used in the DC-DC converter shown in FIG. 4. The comparator shown in FIG. 10 has a third capacitor C53 at the input port of the first inverter, and further has a fourth capacitor C54 between the first inverter and the second inverter, and therefore the output signals of the comparator are more stabile, according to principles discussed above.

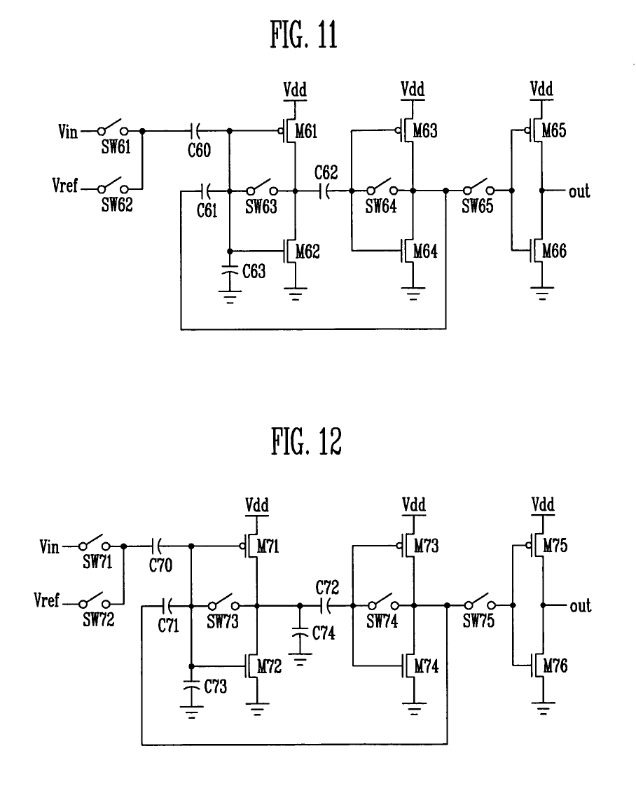

FIG. 11 is a circuit diagram showing another embodiment of a comparator which may be used in the DC-DC converter shown in FIG. 4. The comparator shown in FIG. 11 has a capacitor C63 connected to the first capacitor C61 and to ground, and therefore is operated in a similar manner as capacitor C33, shown in FIG. 8.

FIG. 12 is a circuit diagram showing still another embodiment of a comparator, which can be used in the DC-DC converter shown in FIG. 4. The comparator shown in FIG. 12 has a fourth capacitor C74 connected between the first inverter output and ground. Accordingly, the fourth capacitor C74 is operated in a similar manner as capacitor C43, shown in FIG. 9.

The DC-DC converter and the organic light-emitting display using the same may be useful to increase a response rate by varying the voltage input to the inverter to increase a changing level of the output voltage. Also, the DC-DC converter of the present invention may reduce power consumption by shutting off the inverter circuit to prevent flow of the current if the input/output unit is not operated.

Although certain inventive embodiments have been shown and described in detail, the embodiments mentioned herein are examples for the purpose of illustrations only, and are not intended to limit the scope of the invention to these embodiments. Also, it would be appreciated by those skilled in the art that changes might be made in these embodiments without departing from the principles and spirit of the invention.

What is claimed is:

1. A comparator configured to receive an input voltage and a reference voltage and to determine an output corresponding to a difference between the input voltage and the reference voltage, the comparator comprising:
an input unit configured to transmit the input voltage to a first stage and to transmit the reference voltage to a second stage;
an amplification unit comprising:
a first capacitor configured to store the input voltage and the reference voltage;
a second capacitor configured to receive a feedback voltage and to transmit the feedback voltage to the first capacitor; and
at least one inverter configured to output signals corresponding to the voltage stored in the first capacitor and the second capacitor;
a feedback unit configured to receive a voltage output in the amplification unit when the input voltage is transmitted;
a voltage output unit in the amplification unit, the voltage output unit configured to generate the feedback voltage when the reference voltage is transmitted, wherein the feedback unit is configured to modify a difference voltage corresponding to the difference between the input voltage and the reference voltage according to the feedback voltage; and
an output unit configured to receive the output voltage of the amplification unit and to output a voltage based on the output voltage of the amplification unit.

2. The comparator according to claim 1, wherein the first stage includes a first input port configured to receive the input voltage and a first switch connected between the first capacitor and configured to selectively connect the input voltage to the first capacitor, and the second stage includes a second switch connected between the reference voltage and the first capacitor and configured to selectively connect the reference voltage to the first capacitor.

3. The comparator according to claim 1, wherein the amplification unit includes at least two inverters, and a third capacitor is connected between the inverters, wherein the capacitor is configured to store a threshold voltage difference between the inverters.

4. The comparator according to claim 1, wherein the second capacitor is connected to an input port of the at least one inverter and to ground.

5. The comparator according to claim 1, wherein the second capacitor is connected with the first capacitor in series, and is connected between the first capacitor and the input port of the inverter.

6. The comparator according to claim 1, wherein the feedback unit is configured to transmit the feedback voltage to the first capacitor from the inverter during a time when the output unit outputs the voltage based on the output voltage of the amplification unit and between a time when the input voltage is transmitted to the first stage and a time when the reference voltage is transmitted to the first stage.

7. The comparator according to claim 1, further comprising a fourth capacitor connected to the second capacitor and configured to store the feedback voltage.

8. The comparator according to claim 3, comprising a fourth capacitor connected to the third capacitor.

9. The comparator according to claim 3, comprising a fourth capacitor connected to the second capacitor and a fifth capacitor connected to the third capacitor and to the fourth capacitor, the fifth capacitor configured to store the feedback voltage of the inverter.

10. The comparator according to claim 7, wherein the fourth capacitor is connected to the second capacitor, and connected to the input port of the inverter.

11. The comparator according to claim 9, wherein the third capacitor is connected to the second capacitor, and to the input port of the inverter.

12. The comparator according to claim 1, wherein the output unit is configured to output a signal with a high level of voltage if the difference between the reference voltage and the input voltage is positive, and to output a signal with a low level of voltage if the difference between the reference voltage and the input voltage is negative.

13. The comparator according to claim 1, wherein the feedback unit is configured to use the signal stored in the second capacitor to modify the signal stored in the first capacitor.

14. The comparator according to claim 1, wherein the amplification unit comprises at least two inverters, and the second capacitor is connected between the inverters and is configured to store a threshold voltage difference between the inverters.

15. The comparator according to claim 1, wherein the amplification unit is connected to the input unit and to the second capacitor, and the input unit and the second capacitor are configured to sequentially input the input voltage, the feedback voltage, and the difference voltage to the amplification unit.

16. A DC-DC converter comprising:
a charge pump including:
a voltage output terminal configured to vary and output a voltage according to a voltage at a voltage input terminal; and
a signal input terminal; and
a comparator configured to receive a comparator input voltage and a reference voltage, and to determine an output voltage corresponding to a difference between the comparator input voltage and the reference voltage,
wherein the comparator comprises:
an input unit configured to transmit the input voltage to a first stage and to transmit the reference voltage to a second stage;
an amplification unit comprising:
a first capacitor configured to store the input voltage and the reference voltage;
a second capacitor configured to receive a feedback voltage and to transmit the feedback voltage to the first capacitor; and
at least one inverter configured to output signals corresponding to the voltage stored in the first capacitor and the second capacitor;
a feedback unit configured to receive a voltage output in the amplification unit when the input voltage is transmitted;
a voltage output unit in the amplification unit, the voltage output unit configured to generate the feedback voltage when the reference voltage is transmitted, wherein the feedback unit is configured to modify a difference voltage corresponding to the difference between the input voltage and the reference voltage according to the feedback voltage; and
an output unit configured to receive the output voltage of the amplification unit and to output a voltage based on the output voltage of the amplification unit.

17. The DC-DC converter according to claim 16, wherein the first stage includes a first input port configured to receive the input voltage and a first switch connected between the first capacitor and configured to selectively connect the input voltage to the first capacitor, and the second stage includes a second switch connected between the reference voltage and the first capacitor and configured to selectively connect the reference voltage to the first capacitor.

18. The DC-DC converter according to claim 16, wherein the amplification unit includes at least two inverters, and a third capacitor is connected between the inverters, wherein the capacitor is configured to store a threshold voltage difference between the inverters.

19. The DC-DC converter according to claim 16, wherein the second capacitor is connected to an input port of the at least one inverter and to ground.

20. The DC-DC converter according to claim 16, wherein the second capacitor is connected with the first capacitor in series, and is connected between the first capacitor and the input port of the inverter.

21. The DC-DC converter according to claim 16, wherein the feedback unit is configured to transmit the feedback voltage to the first capacitor from the inverter during a time when the output unit outputs the voltage based on the output voltage of the amplification unit and between a time when the input voltage is transmitted to the first stage and a time when the reference voltage is transmitted to the first stage.

22. The DC-DC converter according to claim 16, further comprising a fourth capacitor connected to the second capacitor and configured to store the feedback voltage.

23. The DC-DC converter according to claim 18, comprising a fourth capacitor connected to the third capacitor.

24. The DC-DC converter according to claim 18, comprising a fourth capacitor connected to the second capacitor and a fifth capacitor connected to the third capacitor and to the fourth capacitor, the fifth capacitor configured to store the feedback voltage of the inverter.

25. The DC-DC converter according to claim 22, wherein the fourth capacitor is connected to the second capacitor, and connected to the input port of the inverter.

26. The DC-DC converter according to claim 24, wherein the third capacitor is connected to the second capacitor, and to the input port of the inverter.

27. The DC-DC converter according to claim 16, wherein the output unit is configured to output a signal with a high level of voltage if the difference between the reference voltage and the input voltage is positive, and to output a signal with a low level of voltage if the difference between the reference voltage and the input voltage is negative.

28. The DC-DC converter according to claim 16, wherein the feedback unit is configured to use the signal stored in the second capacitor to modify the signal stored in the first capacitor.

29. An organic light-emitting display comprising:
a pixel unit configured to display an image corresponding to data signals and scan signals;
a data driver configured to transmit the data signals to the pixel unit;
a scan driver configured to transmit the scan signals to the pixel unit; and
a DC-DC converter to transmit a power supply to the pixel unit, the data driver and the scan driver,
wherein the DC-DC converter comprises a comparator comprising:
an input unit configured to transmit the input voltage to a first stage and to transmit the reference voltage to a second stage;
an amplification unit comprising:
a first capacitor configured to store the input voltage and the reference voltage;
a second capacitor configured to receive a feedback voltage and to transmit the feedback voltage to the first capacitor; and
at least one inverter configured to output signals corresponding to the voltage stored in the first capacitor and the second capacitor;
a feedback unit configured to receive a voltage output in the amplification unit when the input voltage is transmitted;
a voltage output unit in the amplification unit, the voltage output unit configured to generate the feedback voltage when the reference voltage is transmitted, wherein the feedback unit is configured to modify a difference voltage corresponding to the difference between the input voltage and the reference voltage according to the feedback voltage; and
an output unit configured to receive the output voltage of the amplification unit and to output a voltage based on the output voltage of the amplification unit.
